(19) United States
(12) Patent Application Publication
(10) Pub. No.: US 2025/0242604 A1
(43) Pub. Date: Jul. 31, 2025

(54) PRESSURE REGULATION FOR OVERPRESSURES IN A SUCTION CHAMBER OF A FLATBED PRINTER

(71) Applicant: Canon Production Printing Holding B.V., Venlo (NL)

(72) Inventors: Sven BEEKERS, Venlo (NL); Peter PEUTERS, Venlo (NL)

(73) Assignee: Canon Production Printing Holding B.V., Venlo (NL)

(21) Appl. No.: 19/030,331

(22) Filed: Jan. 17, 2025

(30) Foreign Application Priority Data
Jan. 29, 2024 (EP) 24154510.2

(51) Int. Cl. B41J 3/28; B41J 11/00; B41J 29/393

(52) U.S. Cl. CPC B41J 3/28; B41J 11/0085; B41J 29/393

(57) ABSTRACT

The stability of print media supporting on an air bearing on a flatbed printer is improved by the printer including a medium support surface provided with through-holes in connection to a suction chamber assembly; a pressure regulator assembly configured for selectively connecting the through-holes to a suction source or an overpressure source for respectively drawing in gas into or blowing gas from the through-holes, wherein a sensor is provided for determining a pressure in the suction chamber assembly, which sensor is connected to a controller configured to compare the determined to one of a plurality of pressure settings for maintain the pressure in the suction chamber assembly substantially constant based thereon.

### BACKGROUND OF THE INVENTION

### 1. Field of the Invention

The invention relates to a printer and a method of printing.

### 2. Description of Background Art

Flatbed printers comprise a relatively large vacuum table over which a printhead carriage is movable in both horizontal directions to print images on large or multiple print media held on the table by a negative pressure. Each print medium is generally positioned manually on a medium support surface of the vacuum table. US2021394528 A1 discloses a printer comprising a medium support surface provided with through-holes in connection to a suction chamber assembly, and a pressure regulator assembly configured for selectively connecting the through-holes to a suction source or an overpressure source for respectively drawing in gas into or blowing gas from the through-holes. The blown gas may act as an air bearing which allows print media to be slid over the medium support surface with little force to position the print media in their intended positions. It was found that in practice when arranging multiple print media, specifically of different densities, on the medium support surface, not all media were reliably transported or held.

### SUMMARY OF THE INVENTION

It is an object of the invention to improve the loading and positioning of print media on a flatbed printer for a relatively wide range of print media.

In accordance with the present invention, a printer according to claim 1 and a method of printing according to claim 13 are provided.

The printer comprises:
a medium support surface provided with through-holes in connection to a suction chamber assembly;
a pressure regulator assembly configured for selectively connecting the through-holes to a suction source or an overpressure source for respectively drawing in gas into or blowing gas from the through-holes.

A sensor is provided for determining a pressure in the suction chamber assembly, which sensor is connected to a controller configured for controlling the pressure regulator assembly to maintain the pressure substantially constant when an overpressure is applied.

It is the insight of the inventor that a controlled flow of gas blown via the through-holes is required to allow the print media to hover stably over the medium support surface. It is the further insight of the inventor that a sensor which determines the pressure of the gas can be used to control the gas flow to achieve the desired stability. By maintaining the pressure relatively constant, the lifting force per unit area of the gas flow is kept substantially constant. The force per area is then made substantially is thus controllably maintained regardless of the area of the medium support covered and/or the total combined area of the one or more print media. Thus, adding and/or removing print media regardless of their weight per unit area does not substantially affect the lifting force per unit area. This provides accurate control over the behavior of the print media on the medium support surface.

The pressure regulator assembly can adjust and set the overpressure below the medium support surface, which overpressure forces the gas out through the through-holes during use. The controller controls the pressure regulator assembly based on the pressure determined from the sensor. This allows the pressure to be kept substantially constant with respect to e.g. a predetermined, selected pressure setting. The controller may for example apply feedback and/or feedforward control to regulate the pressure, which prevents print media from ‘drifting away’ when not held in place by e.g. the operator, due to a change in pressure when other media are added or removed from the medium support surface. Additionally, the applied overpressure is preferably selected to suit the applied print media. Once selected, the overpressure is maintained substantially constant when adding or removing more print media of similar density and thickness. The controller ensures that the overpressure remains substantially constant, regardless of the coverage of print media on the medium support surface. In consequence, the lifting force per unit area remains substantially constant. Drifting away can be prevented by selecting an overpressure wherein a print medium maintains slight frictional contact with the medium support surface, so that it still be slid easily across said surface with little force, yet remains in position in absence of any external pushing forces. This results in reliable and predictable behavior for the operator. That in turn allows both relatively light and heavy print media to be easily handled and positioned in this manner. The same applies to relatively porous and non-porous media. Thereby the object of the present invention has been achieved.

More specific optional features of the invention are indicated in the dependent claims.

In an embodiment, the controller is further configured to compare the determined pressure to one of a plurality of pressure settings for controlling the pressure in the suction chamber assembly based thereon. Different overpressures may be set during loading dependent on the requirements of the print media and/or the operator. Each pressure setting corresponds to a value for the applied overpressure. For example, larger overpressures may be applied to print media with greater densities as compared to lighter print media.

In an embodiment, the printer further comprises a user interface connected to the controller, which user interface is configured for selecting one of the plurality of pressure settings. Multiple pressure settings are stored on the controller's memory. Each pressure setting corresponds to a different, intended gas pressure at the sensor. By selecting or inputting a pressure setting on the user interface, the controller controls the pressure regulator assembly to substantially maintain the pressure in the suction chamber assembly at the pressure corresponding to the pressure setting. The pressure setting may be input numerically or selected via a predefined button or slider on a screen of the user interface. Other input means may be applied as well. The user interface may also be configured for inputting print job information, wherein the controller determines a suitable pressure setting from the print job information and selects said pressure setting when print media are to be loaded for said print job.

In an embodiment, the plurality of pressure settings comprise a plurality of different overpressure settings stored on the controller, wherein each overpressure setting is configured to provide a different gas flow through the through-holes. The different overpressure settings achieve different overpressures in the suction chamber assembly, which results in different air flows through uncovered through-holes in the medium support surface. Greater overpressures create stronger or faster air flows as compared to relatively smaller overpressures. In another embodiment, the plurality of pressure settings comprises a plurality of different negative pressure settings stored on the controller, wherein each negative pressure setting is configured to provide a different negative pressure at the through-holes. The negative pressures are applied to fix print media onto the medium support surface. Different negative pressure may be applied to different types of print media.

In an embodiment, the controller is configured to apply the overpressure settings in a medium loading mode of the printer and to apply the negative pressure settings in a printing mode of the printer, wherein in the medium loading mode the controller prevents printheads from printing in an area of the medium support surface where the print media are to be loaded, and wherein in the printing mode the controller controls the printheads to print on the print media in said area. In the printing mode, the print media are held in position by the applied negative pressure. In the medium loading mode, the print media are moved into their intended positions using the air bearing generated via the selected overpressure.

In an embodiment, the controller is configured to compare the determined pressure to the selected overpressure setting and control the pressure regulator assembly to maintain a substantially constant pressure based on said comparison. The controller is provided with a control algorithm to maintain the determined pressure substantially constant with respect to the selected pressure setting. The pressure as determined by sensor is therein compared to the selected pressure setting and the controller seeks to minimize the difference between the determined pressure and the pressure corresponding to the selected pressure setting.

In an embodiment, the controller is provided with a pressure regulating algorithm for maintaining the determined pressure substantially at a value corresponding to an selected overpressure setting. The algorithm may be provided digitally on the controller's memory or in the form of an electronic circuit. Suitable algorithms may comprise feedback control such as open loop, closed loop, P, PI, or PID loops, feedforward control, and/or self-learning control algorithms, etc.

In an embodiment, the suction chamber assembly comprises at least one pressure chamber delimited by a plate comprising the medium support surface, in which at least one pressure chamber the sensor is positioned. The respective pressure chamber is adjacent the through-holes. The sensor is provided in the suction chamber to determine a pressure in a chamber directly connected to the through-holes. Multiple sensors may be applied as well.

In an embodiment, a manifold of channels extending perpendicular to the medium support surface is provided on an opposite side of the at least one pressure chamber with respect to the medium support surface, wherein the channels are provided in a matrix with substantially constant density. A relatively large number of channels is provided, for example at least 10 per m², very preferably at least 20 per m². The individual channels have a respective cross-section several times larger than that of the through-holes. Gas can travel easily through the channels in the during use vertical direction. Every through-hole is relatively near a channel, when viewed from above. The distance between a through-hole and its nearest channel in the horizontal direction is relatively small. This ensures that gas moves quickly and easily from the through-holes to the channels and beyond, or in the opposite direction. Preferably, every through-hole has no more than 20, preferably nor more than 10 through-holes, between itself and the nearest channel, when viewed from above. This ensures that gas can be effectively removed from or transported to the through-holes. The channels are connectable at one end to the suction source and the overpressure source.

In an embodiment, the printer is a flatbed inkjet printer. The media support surface is formed by relatively large plate with through-holes. A gantry comprising a scanning print head carriage is provided movably over the medium support surface.

In an embodiment, the printer further comprises at least one rapid re-pressurization unit, which comprises a release opening which connects the suction chamber assembly to the ambient, a sealing member, and an actuator configured for moving the sealing member to selectively open and seal the release opening, wherein the pressure regulator assembly is arranged to further control the actuator to adjust the sealing member to adjust the pressure in the suction chamber assembly. During printing print media are sucked against the medium support surface. After stopping the suction source, the pressure inside the suction chamber assembly remains negative for a certain period. As a result, the print media remain adhered to the surface and cannot be removed directly after printing. This delay can be reduced or prevented by opening the release opening, such that the inner volume of the suction chamber assembly is quickly connected to the ambient. This rapidly re-pressurizes the inner volume to (near) atmospheric pressure, allowing the print media to be quickly removed. When applying negative pressures, the sealing member is positioned over the release opening, so that the release opening is sealed with respect to the ambient. When printing is complete, the actuator is triggered to move the sealing member away from the sealing opening, so that it is opened to the ambient. A relatively large size of the release opening allows for a rapid pressure change. The sealing member and the actuator may be shared between the rapid re-pressurization unit and the pressure regulator assembly. The release opening is preferably positioned near a connection of the suction source and/or overpressure source to the suction chamber assembly. The actuator can move the sealing member between a sealing position and a release position. In the sealing position the sealing member seals the release opening, but also at least partially extends into the connection line of the suction source and/or overpressure source to the suction chamber assembly. The actuator can adjust the position of the sealing member, so that the flow resistance of the connection line between the suction source and/or overpressure source and the suction chamber assembly can be adjusted. This allows the pressure in the suction chamber to be controlled by adjusting the position of the sealing member within the connection line. In one example, the sealing member is a plate that covers the release opening in the sealing position. The plate further can selectively close off a portion of the respective connection line of the suction source and/or overpressure source to the suction chamber assembly. In this manner the number of components is kept low.

The present invention further relates to a method of printing on a flatbed printer, the method comprising the steps of:
blowing gas through the medium support surface to float a print medium above the medium support surface;
sucking a print medium against a medium support surface,
determining a pressure of the gas;
maintaining the pressure of the gas substantially at a level corresponding a predetermined pressure setting.

The gas pressure is regulated based on comparing e.g. pressure measurements of the gas to the pressure setting. This ensures that the gas overpressure is substantially constant and at a level sufficient level to lift a certain print medium from the medium support surface. This ensures that lifting force per unit area applied to a print medium remains substantially constant, when other media are added or removed. The pressure is preferably selected, so that the print medium can be slid easily over the medium support surface, yet remains in place when not engaged by an operator. This low frictional interaction prevents the print medium from drifting out of position or off the vacuum table when the operator works on another medium. An operator can easily move the print media using this flow of gas into their intended positions, where these will remain. Then, the flow of gas is reversed to suck the print medium in place on the medium support surface, so that it can be printed on.

In an embodiment, the method further comprises the step of selecting one of a plurality of pressure settings, wherein each of said pressure settings corresponds to a different pressure of the gas. Different pressure settings have been pre-stored on the printer. This allows a suitable overpressure to be applied for each type of print medium.

In an embodiment, a sensor is provided near the medium support surface for determining of the pressure of the gas. The gas pressure is determined via a sensor, which sensor is coupled to controller, which in turn controls the pressure regulator assembly to maintain the pressure at or near the selected pressure setting.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic perspective view of a flatbed printer;

FIG. 2 is a schematic cross-sectional view of a suction chamber assembly of the flatbed printer in FIG. 1;

FIG. 3 is a schematic cross-sectional view of the suction chamber assembly in FIG. 2 in a printing mode of the flatbed printer in FIG. 1;

FIG. 4 is a schematic cross-sectional view of the suction chamber assembly in FIG. 2 in a medium loading mode at a first pressure setting of the flatbed printer in FIG. 1;

FIG. 5 is a schematic cross-sectional view of the suction chamber assembly in FIG. 2 in a medium loading mode at a second pressure setting of the flatbed printer in FIG. 1;

FIG. 6 is a schematic cross-sectional view of the suction chamber assembly in FIG. 2 in a medium loading mode at a third pressure setting of the flatbed printer in FIG. 1;

FIG. 7 is a schematic representation of a user interface of the printer in FIG. 1;

FIG. 8 is a schematic cross-sectional view of another embodiment of the suction chamber assembly of the flatbed printer in FIG. 1;

FIG. 9 is a schematic cross-sectional view of a further embodiment of the suction chamber assembly of the flatbed printer in FIG. 1 provided with a rapid re-pressurization unit in a sealed state; and

FIG. 10 is a schematic cross-sectional view of the further embodiment in FIG. 9 provided with a rapid re-pressurization unit in an open state.

### DETAILED DESCRIPTION OF THE PREFERRED EMBODIMENTS

The present invention will now be described with reference to the accompanying drawings, wherein the same reference numerals have been used to identify the same or similar elements throughout the several views.

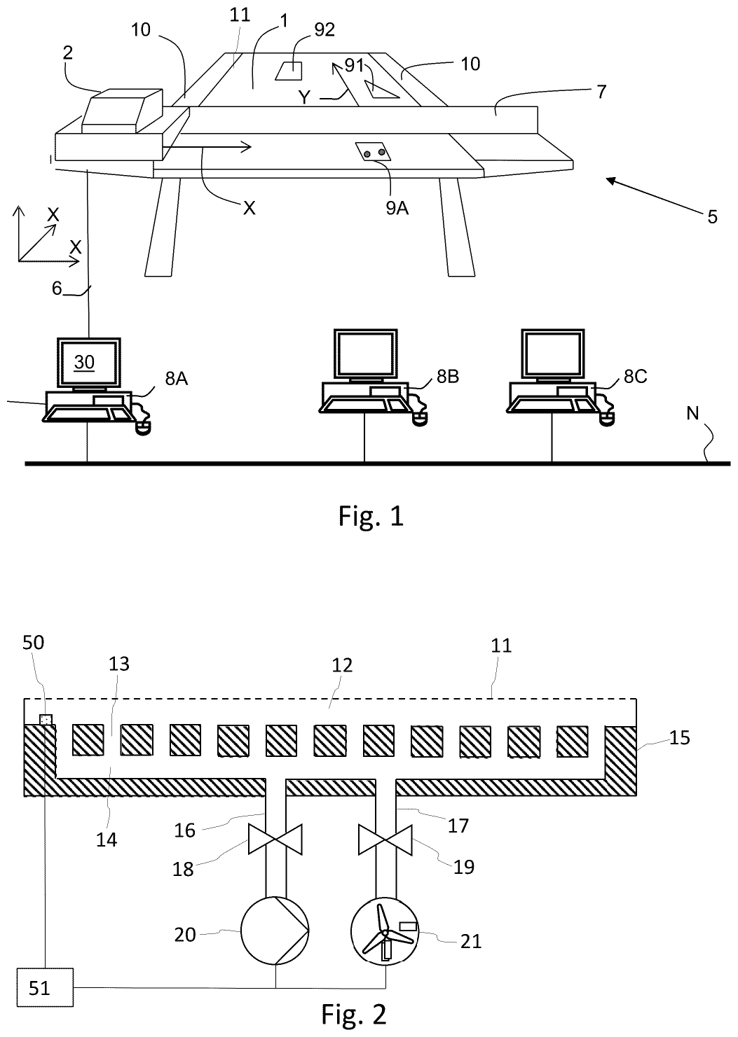

FIG. 1 is a printer 5 comprising a number of workstations 8B, 8C, which may be personal computers or other devices for preparing image data for prints to be printed. These workstations have access to a network N for transferring print jobs comprising the image data to a print controller 8A that is configured to receive the print jobs for prints and derive pass images. The print controller 8A may be part of the printer 5 connected to a control unit of the printer 5 via a connection 6. The printer 5 further comprises a print head 2 attached to an armature 7 for applying colorants, for example cyan (C), magenta (M), yellow (Y), black (K) and white (W) colorant, or varnish to pieces 9, 9A of flat print media placed on a flatbed surface 1 in order to obtain a printed image. The armature 7 may comprise a gantry above the flat bed surface 1 as shown in FIG. 1 or a robot arm (not shown) moving in a plurality of directions over the flat bed surface 1. The flatbed surface 1 is the surface of the flatbed which is at least partially printable by the print head 2. The pieces of media may be so small that they are completely placed on the flatbed surface 1, but a piece of media which is larger than the flatbed surface, in which case an image which is going to cover the whole piece of media must be printed into a plurality of parts of the image, is not excluded. A first piece 9A has already been printed upon, while the other pieces 91, 92 are not provided with any recording material yet. The print head 2 reciprocally scans the flatbed surface 1 in the second direction X along a gantry 7 perpendicular to a first direction Y of the gantry 7 over the flatbed surface 1 along guiding parts 10. During printing of an image on the piece 9, 9A of media the piece 91, 92, 9A of media is not moved on the flatbed surface 1. This way of working is advantageous for rigid print media. A print head which is as wide as the flatbed surface may also be envisaged within the scope of the invention. Such a print head may be moveable in at least one direction over the flatbed surface 1.

The flatbed surface 1 comprises a medium support surface 11. The medium support surface 11, as shown in FIG. 2, is provided with through-holes to allow air to pass through the medium support surface 11. A pressure chamber 12 is provided below medium support surface 11 as part of a suction chamber assembly 15. By applying a negative pressure in the pressure chamber 12, print media can be securely and flatly held against the medium support surface 11. A suction source 20 is provided to form the negative pressure in the pressure chamber 12. Fans or pumps etc. may be applied as suction source 20. The suction source 20 is connected to a manifold 13 positioned below the pressure chamber 12. The pressure chamber 12 is preferably relatively narrow in the vertical direction Z. The manifold 13 comprises a large plurality of parallel channels with a relatively large diameter to provide a vertical connection to the suction source 20. The vertical channels are provided in a relatively high and constant density, so that each through-hole in the medium support surface 11 is relatively near or adjacent to a channel. For example, no more than five to ten through-holes are positioned between each through-hole and its nearest channel. This allows the negative pressure to be maintained effectively at each through-hole. The manifold 13 on its bottom side is connect to a large flow chamber 14, which connects to the suction source 20 via the suction line 16. A pressure regulator 18 in the form of a valve is provided in the suction line 16 to adjust the negative pressure. Alternatively, the negative pressure may be regulated by controlling the suction source 20, e.g. by adjusting its speed. The negative pressure is applied to hold print media securely onto the medium support surface 11 during printing.

Similarly, an overpressure source 21 is provided in connection to the flow chamber 14 via the overpressure line 17. The overpressure source 21 may also be a pump or fan. The overpressure may be regulated by means of the pressure regulator 19, which comprise a valve for at least partially opening and closing the overpressure line 17. The pressure regulators 18, 19 are preferably controlled, so that one of the suction line 16 and the overpressure line 17 is closed, when respectively a negative pressure or overpressure is applied via the other line 16, 17. Due to the relatively low air resistance of the manifold 13, the overpressure can be effectively applied to each through-hole via the pressure chamber 12. In consequence, air is blown out from the through-holes. This results in an air bearing, which can support a print medium, so that it floats or hovers just above the medium support surface 11. Since the print medium is above the medium support surface 11 on the air bearing, it can be relatively easily moved in the horizontal directions X, Y. This reduces the effort required for loading and positioning print media on the medium support surface 11.

The pressure chamber 12 further comprises at least one pressure sensor 50 configured to determine the pressure in the pressure chamber 12. The pressure sensor 50 may directly or indirectly detect the pressure in the pressure chamber 12. Suitable pressure sensors, such as manometers, strain gauges, capacitive or piezoelectric sensors, etc. may be applied. The pressure sensor 50 transmits a pressure signal to the controller 51, which applies this pressure signal to control the suction source 20 and/or the overpressure source 21 and/or the assembly of pressure regulators 18, 19. The controller 51 compares the pressure signal to set or selected pressure setting. The controller 51 comprises a pressure regulating algorithm, for example a feedback loop, to maintain the pressure in the suction chamber 12 at or near the pressure setting. The controller 51 e.g. may comprise for example a PID controller configured to maintain the pressure at or near the pressure setting. Different controllers or algorithms may be applied for respectively the suction source 20 and the overpressure source 21. It will be appreciated that the pressure may also be controlled indirectly for example by basing a control algorithm on the speed and/or power of the suction or overpressure source. 20, 21

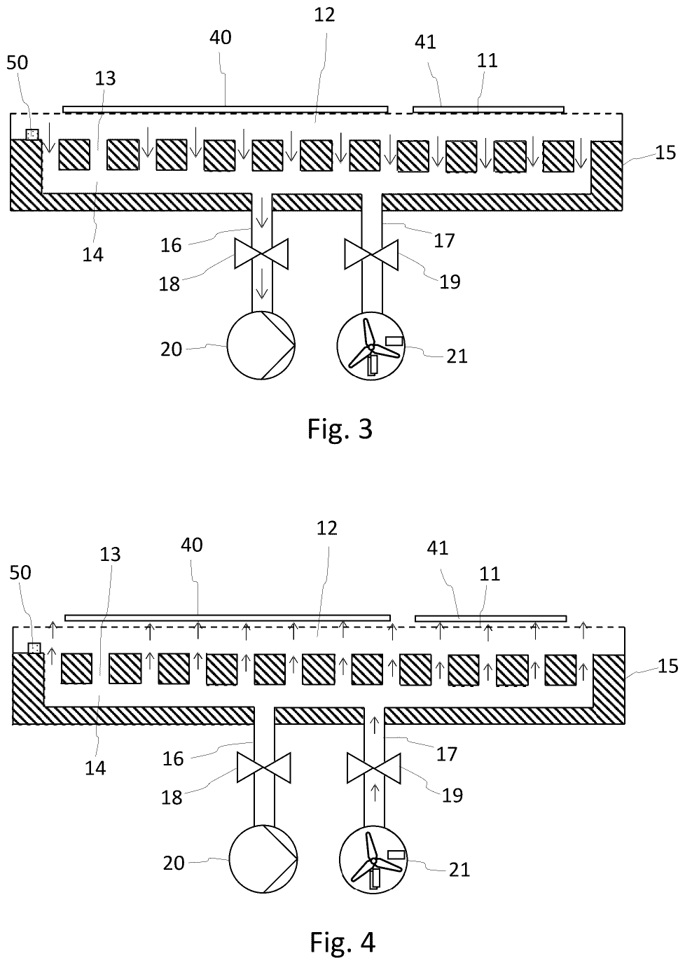

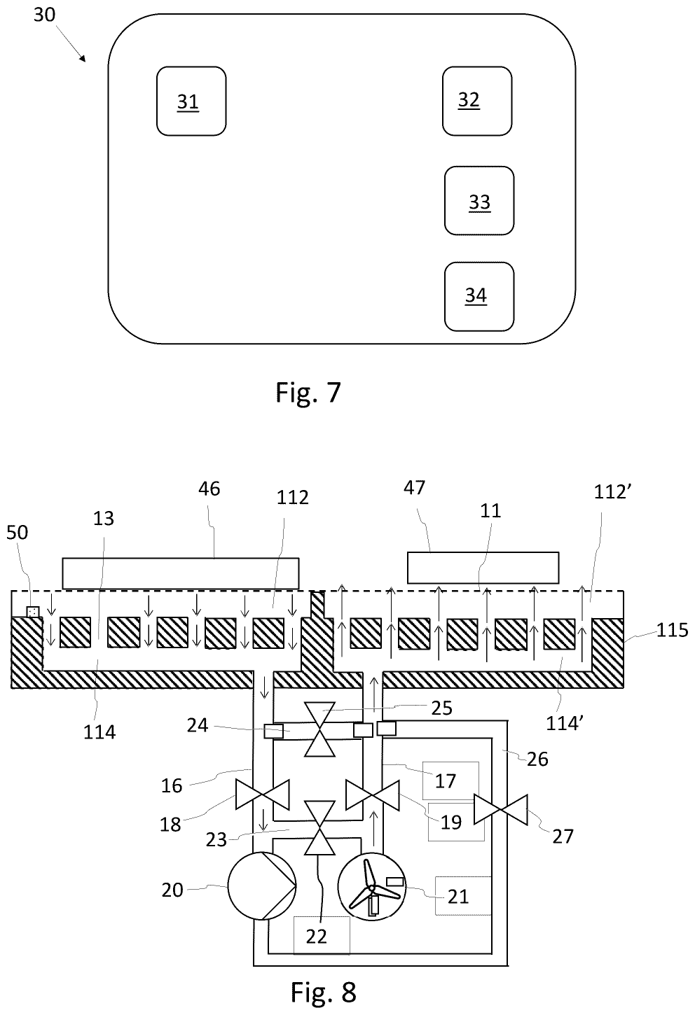

FIG. 3 illustrates the controller 51 being set to operate in a medium holding mode. In the medium holding mode, the controller 51 controls the suction source 20 and the pressure regulators 18, 19, so that a negative pressure is applied to the pressure chamber 12. Air is then drawn in via the through-holes in the medium support surface 11, as indicated by the arrows. The print media 40, 41 are sucked against the medium support surface 11 and are securely held in place due to the frictional forces between the print media 40, 41 and the medium support surface 11. In FIG. 3, the suction source 20 is active and the pressure regulator 18 is open to connect the suction source 20 to the pressure chamber 12. The overpressure source 21 may be de-activated and the other pressure regulator 19 closes the overpressure line 17. The medium holding mode is applied during printing, wherein the carriage 2 and the gantry 7 move over the medium support surface 11. The controller 51 may be set to the medium holding mode via the user interface 30 via the medium holding mode activator 31, as shown in FIG. 7. The medium holding mode activator 31 is e.g. a button on the user interface 30 that activates the medium holding mode. The operator may for example press this button after all print media have loaded and positioned. In the example in FIG. 7, the medium holding mode defines a single pressure setting, which the controller 41 uses to regulate the pressure in the pressure chamber 12. The pressure is measured by the pressure sensor 50 and regulated by the controller 51 via a medium holding mode pressure regulating algorithm based on said measurement. The medium holding mode may also be automatically entered when the controller starts a print job. It will be appreciated that dependent on the number and/or type of print media, different negative pressure settings may be applied via the controller 51.

FIG. 4 illustrates the controller 51 being set to operate in a first medium loading mode for relatively light print media 40, 41, like paper, foil, or sheets. In this mode, the suction source 20 and its corresponding pressure regulator 18 are prevented from applying a pressure in the pressure chamber 12, for example by closing the suction line 16. The overpressure source 21 has been activated by the controller 51 and the pressure regulator 19 is controlled based on the pressure sensor 50 to maintain the pressure in the pressure chamber 12 constant at the level corresponding to a first overpressure setting. The pressure may be regulated directly, by measuring the pressure itself and adjusting the pressure regulator based thereon, and/or indirectly for example by adjusting the speed of a fan or pump comprised pressure regulator. The pressure sensor may be any suitable type sensor for directly or indirectly sensing a parameter proportional to the pressure, for example strain gauges, piezoelectric sensors, capacitive sensors, manometers, pressure switches, pressure transducers, flow-based and/or temperature based pressure sensors.

The first medium loading mode is selected via the user interface 30 by means of the first medium loading mode activator 32, illustrated as a button in FIG. 7. Selecting the first medium loading mode comprising setting a first overpressure setting. In this example, the first overpressure setting is stored on the controller's memory and automatically selected and set, when the first medium loading mode is activated. The controller 51 controls the pressure regulator 19, so that the overpressure source 19 applies a first negative pressure in the pressure chamber 12 corresponding to the first overpressure setting. The resulting air flow is relatively small as indicated by the arrows, but sufficiently great to slightly lift and maintain the print media 40, 41, resulting in a small frictional interaction between the print medium 40, 41 and the medium support surface 11. The friction interaction is sufficient to keep the print medium 40, 41 in position when it rests on said surface, but is sufficiently small, so that the print medium can be slid across said surface with little force. Since the pressure regulator 17 actively maintains the pressure in the pressure chamber 12 at or near the intended first negative pressure, the pressure in the pressure chamber 12 is relatively constant. This prevents the print media 40, 41 from floating over and off the medium support surface 11. This allows an operator to release one print medium 40, 41, so that it remains substantially in place. Thus, the operator can position multiple print media 40, 41 on the medium support surface 11 in this manner. It will be appreciated that overpressures with gas flow that fully lift the print media from the medium support surface may be applied as well.

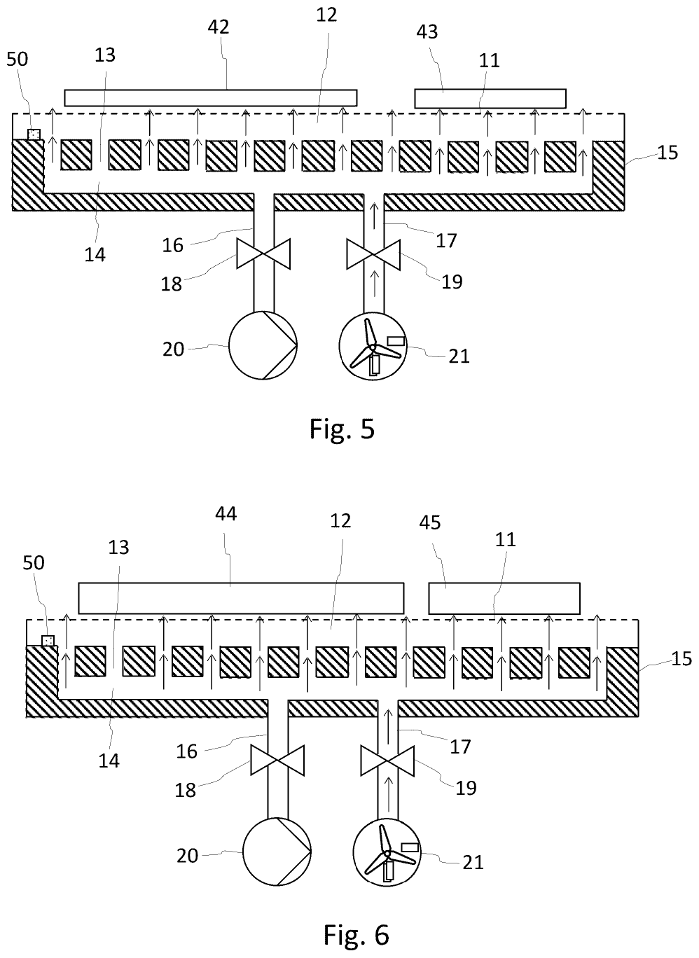

FIG. 5 illustrates the loading of print media 42, 43 of moderate weight, for example plastic sheets or substrates. The first overpressure setting is insufficient to lift these print media 42, 43 from the medium support surface 11. A second overpressure setting is then selected by choosing the second medium loading mode via the user interface 30. By selecting the button forming the second medium loading mode activator 33, the controller 51 retrieves the second overpressure setting from its memory and applies this in its overpressure regulating algorithm, so that the pressure in the pressure chamber 12 is maintained at or near a second negative pressure, corresponding to the second overpressure setting. As shown by the arrows in FIG. 5, the air flow here is relatively moderate and greater than that in FIG. 4. In consequence, the cardboard substrates 42, 43 are lifted from the medium support surface 11, but without substantially displacing these in the horizontal direction (unless being moved by the operator or another external force).

FIG. 6 illustrates the loading of relatively heavy print media 44, 45, for example in the form of wooden or glass panels. As the first and second overpressure settings are insufficient, the third medium loading mode is selected by pressing the button which forms the third medium loading mode activator 34. This sets the controller 51 to apply a third pressure setting, which results in an overpressure further removed from ambient pressure as compared to when the first and second pressure settings are applied. This results in the relatively large air flows, indicated by the arrows, which air flow is sufficient to lift the wooden panels from the medium support surface 11. Thus, a single operator is then able to position such heavy print media 44, 45.

FIG. 7 illustrates the user interface 30 with the activators 31-34. It will be appreciated that alternatively, the user interface may allow the operator to directly set a pressure setting, for example via inputting a numeric value or an adjustable slider on the user interface. In another embodiment, the controller 51 selects the appropriate pressure setting from information in the uploaded print job.

FIG. 8 illustrates an alternative configuration of the suction chamber assembly 115. The suction chamber assembly 115 comprises two independently controllable pressure chambers 112, 112′. Pressures may be set differently in the first pressure chamber 112 as compared to the second pressure chamber 112′ via the respective flow chamber 114, 114′. Each flow chamber 114, 114′ is connected to the suction source 20 and the overpressure source 21 via a manifold of lines 16, 17, 23, 24, 26 and valves 18, 19, 22, 25, 27, which allow the suction source 20 and the overpressure source 21 to be selectively connected to one or both of the flow chambers 114, 114′. This allows for example one pressure chamber 112 to be at a negative pressure to hold a print medium 46 in place, while the second pressure chamber 112′ is provided with an overpressure to float a print medium 47 above the medium support surface, or vice versa. This allows for printing on one half of the printer 5, while (un) loading print media at the other half. It will be appreciated that more than two independent pressure chambers 112, 112′ may be applied as well in this manner.

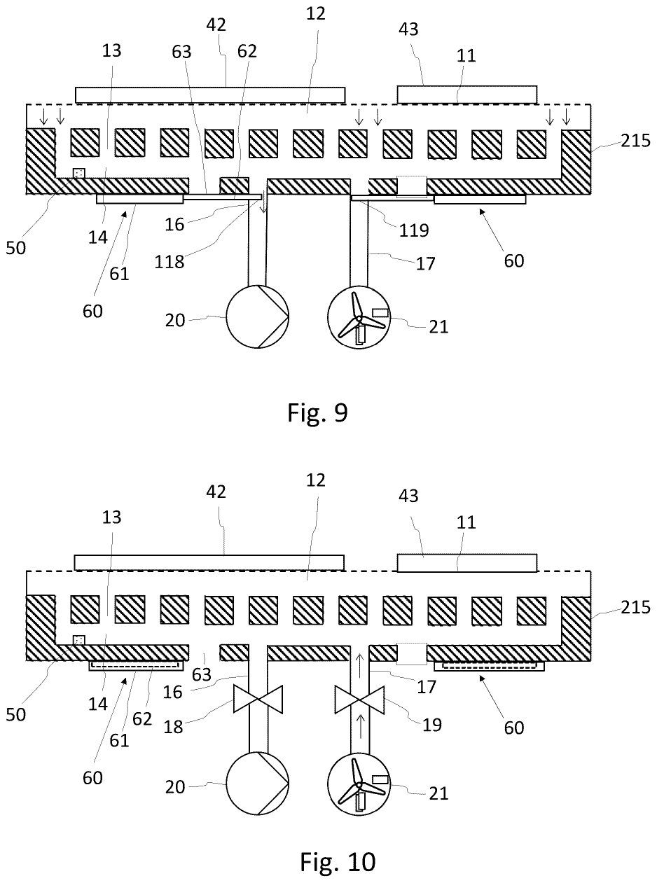

FIG. 9 illustrates a further embodiment of the suction chamber assembly 215 of the flatbed printer in FIG. 1. The suction chamber assembly is similar to that of FIG. 2, but is in FIG. 9 provided with rapid re-pressurization units 60. In addition the sensor 50 has been provided in the flow chamber 14. The bottom surface of the suction chamber assembly 215 is provided with one or more release openings 63. The release openings are relatively large through-holes connecting the flow chamber 14 to the ambient. In FIG. 9 the release openings 63 are formed as holes in the bottom plate of the suction chamber assembly 215 near or surrounding the lines 16, 17. Each rapid re-pressurization unit 60 is provided with a sealing plate 62 that is movable by means of an actuator 61 between a sealing position and an open position. In the sealing position, the sealing plate 62 seals the release opening 63, locally preventing the passage of gas into or out of the flow chamber 14. In the sealing position, the bottom plate of the suction chamber assembly 215 is effectively closed at the release openings 63, so that the suction chamber assembly 15 basically operates as in FIGS. 1-6. This allows print media 42, 43 to be sucked against the medium support surface during printing. It was found that when disabling the suction source 20, print media 42, 43 remain sucked or sticked to the medium support surface for limited period of time afterwards. In this period removal of the print media 42, 43 is cumbersome or even prevented. This is experienced as unproductive by operators. To facilitate a quick release of the print media 42, 43, each actuator 61 is controlled to open the respective release opening 63 by moving the respective sealing plate 62 to the open position, as shown in FIG. 10. Air is able to rapidly enter the suction chamber assembly 215 via the release openings 63. Thereby, the flow chamber 14 is re-pressurized towards atmospheric pressure. The low air flow resistance of the manifold 13 ensures that this re-pressurization is rapidly communicated also to the pressure chamber 12, preferably over the full area of the medium support surface. Thus, by opening the release openings 63 the print media 42, 44 become substantially instantaneously unstuck from the medium support surface. This allows operator to quickly unload and load print media after completing a print job.

In addition, the sealing plate 62 with its actuator 61 forms part of the pressure regulator 118. The line 16 is connected to a basic pump 20. The sealing plate 62 is arranged to partially seal off the line 16, thereby adjusting the flow through line 16 towards the pump. This in turn determines the pressure in the suction chamber 12. The actuator 61 can set the position of the sealing plate 62 inside the line 16 at any position, so that line 16 can be partially closed or entirely sealed off. Thereby, the pressure can be regulated to any desired value. Thus components can be shared between the pressure regulator 118 and the re-pressurization unit 60. The pressure regulator 116 for the overpressure source 21 can be combined with a re-pressurization units 60 in a similar manner.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A printer comprising:
a medium support surface provided with through-holes in connection to a suction chamber assembly;
a pressure regulator assembly configured for selectively connecting the through-holes to a suction source or an overpressure source for respectively drawing in gas into or blowing gas from the through-holes,
wherein a sensor is provided for determining a pressure in the suction chamber assembly, which sensor is connected to a controller configured for controlling the pressure regulator assembly to maintain the pressure substantially constant when an overpressure is applied.

2. The printer according to claim 1, wherein the controller is configured to compare the determined pressure to one of a plurality of pressure settings for controlling the pressure in the suction chamber assembly based thereon.

3. The printer according to claim 1, further comprising a user interface connected to the controller, which user interface is configured for selecting one of the plurality of pressure settings.

4. The printer according to claim 1, wherein the plurality of pressure settings comprise a plurality of different overpressure settings stored on the controller, wherein overpressure setting is configured to provide a different gas flow through the through-holes.

5. The printer according to claim 4, wherein the controller is configured to compare the determined pressure to the selected overpressure setting and control the pressure regulator assembly to maintain a substantially constant pressure based on said comparison.

6. The printer according to claim 5, wherein the controller is provided with a pressure regulating algorithm for maintaining the determined pressure substantially at a value corresponding to an selected overpressure setting.

7. The printer according claim 1, wherein the suction chamber assembly comprises at least one pressure chamber delimited by a plate comprising the medium support surface, in which at least one pressure chamber the sensor is positioned.

8. The printer according to claim 7, wherein a manifold of channels extending perpendicular to the medium support surface is provided on an opposite side of the at least one pressure chamber with respect to the medium support surface, wherein the channels are provided in a high density.

9. The printer according to claim 8, wherein the channels of the manifold are provided in a matrix with substantially constant density.

10. The printer according to claim 9, wherein the channels are provided in A relatively large number of channels per unit area is provided, preferably at least 10 per m², and very preferably at least 20 per m².

11. The printer according to claim 1, further comprising at least one rapid re-pressurization unit, which comprises a release opening which connects the suction chamber assembly to the ambient, a sealing member, and an actuator configured for moving the sealing member to selectively open and seal the release opening, wherein the pressure regulator assembly is arranged to further control the actuator to adjust the sealing member to adjust the pressure in the suction chamber assembly.

12. The printer according to claim 1, wherein the printer is a flatbed printer comprising a gantry movable in a first direction over the medium support surface, and wherein a print head carriage is mounted on the gantry, so that the print head carriage is movable over the medium support surface in a second direction perpendicular to the first direction.

13. A method of printing on a flatbed printer according to claim 12, the method comprising the steps of:
blowing gas through the medium support surface to float a print medium above the medium support surface;
sucking a print medium against a medium support surface,
wherein the step of blowing gas further comprising:
determining a pressure of the gas; and
maintaining the pressure of the gas substantially at a level corresponding to a predetermined pressure setting.

14. The method according to claim 13, wherein the predetermined pressure setting has been selected so that the print medium remains in contact with the medium support surface to prevent it from drifting.

15. The method according to claim 14, further comprising the step of selecting one of a plurality of pressure settings, wherein each of said pressure settings corresponds to a different pressure of the gas.

16. The method according to claim 12, wherein a sensor is provided near the medium support surface for determining of the pressure of the gas.
